(19) United States
(12) Patent Application Publication
(10) Pub. No.: US 2019/0295198 A1
(43) Pub. Date: Sep. 26, 2019

(54) PADTIME LIVE SHOWING

(71) Applicants: Farid Feizian, Woodside, NY (US); Daniel Farina, Columbia, MD (US)

(72) Inventors: Farid Feizian, Woodside, NY (US); Daniel Farina, Columbia, MD (US)

(21) Appl. No.: 16/365,597

(22) Filed: Mar. 26, 2019

Related U.S. Application Data
(60) Provisional application No. 62/647,881, filed on Mar. 26, 2018.

(51) Int. Cl. G06Q 50/16; G06Q 10/10

(52) U.S. Cl. CPC G06Q 50/163; G06Q 10/1095

(57) ABSTRACT

A method for PadTime remote live showings of real estate properties may be disclosed herein. The method may include both a renter or buyer and agent registering for the remote live showing system. The renter or buyer may search for at least on property that meets their specific requirements and request a remote live showing. The agent may receive this information as a lead and schedule a remote live showing. The agent may initiate the remote live showing and the renter or buyer may join the showing.

### CROSS REFERENCE TO RELATED APPLICATIONS

This application is a continuation of U.S. Provisional Patent Application No. 62/647,881 filed on Mar. 26, 2018, the entire disclosure of each and all of the above mentioned references are hereby incorporated herein by reference.

### FIELD OF INVENTION

This application is in the field of real estate.

### BACKGROUND

There is inherent exposure limitation in the rental properties due to in-person showings. Realtors may only show a hand full of properties to potential renters and in some instances have to work around their schedule to be able to show the same property to more than one person at a time, but it has been very challenging.

In-person showings may be time consuming, inefficient, and inconvenient. The process of physically visiting every rental property force a renter to end up settling for less and signing a lease for an apartment without seeing as many properties they might like to.

Due to the current inherited inefficiencies explained, ‘lead to showing’ and ‘lead to renter’ conversation rate has been staggered. Realtors find themselves spending thousands of dollars on advertisements hoping for a better outcome, however this has generated nothing but billions of dollars for the advertisement agencies and platforms.

A need exists for a more convenient and easy way to show potential properties to multiple renters or buyers, and provide an easier way for those renters or buyers to view those potential properties.

### SUMMARY

A method for PadTime remote live showings of real estate properties may be disclosed herein. The method may include both a renter or buyer, a property manager, and an agent registering for the remote live showing system. The renter or buyer may search for at least one property that meets their specific requirements and request a remote live showing, or register for a previously scheduled remote live showing. The agent may receive this information as a lead and schedule a remote live showing. The agent may initiate the remote live showing and the renter or buyer may join the showing.

### BRIEF DESCRIPTION OF THE DRAWINGS

A more detailed understanding may be had from the following description, given by way of example in conjunction with the accompanying drawings wherein:

FIG. 1 is an example architecture of the PadTime live showing system;

FIG. 2 is an example website flow of the PadTime live showing system;

FIG. 3A is a first example method of the PadTime live showing system; and

FIG. 3B is a second example method of the PadTime live showing system.

### DETAILED DESCRIPTION OF THE DRAWINGS

A method of conducting the showing of real estate properties to potential renters or buyers through remote live video showing utilizing a website and mobile application may be described herein. Live real time showing, archived videos, or delayed streams of real estate properties hosted by a realtor, landowner, or property manager (herein known as “agents”) and attended by prospective renters or buyers (herein known as “renters”) may be disclosed. The key may be to combine existing live streaming technologies with existing website and mobile application technologies to allow potential property renters or buyers to visit locations remotely or virtually via live video and instant messaging. Additionally, agents may show a property to multiple renters at the same time remotely, essentially solving the issue of agents having to give separate tours to multiple potential renters. Remote live showings may save renters countless hours by eliminating the need to physically visit a real estate property.

PadTime may enable realtors to show a property to multiple potential renters at the same time. More exposure for a property may mean faster closure on deals, allowing realtors to increase their revenue.

The account creation process may be described herein. Renters may register by submitting an online application or by using third party social media login integrations, for example, Facebook, Instagram, and the like. The renter may also register using special links provided by the agents.

Agents may register by submitting an online application or by using third party social media login integrations, for example Facebook, Instagram, and the like. The agents may also obtain access to their accounts via an automated process where PadTime creates their accounts ahead of time with prior permission. This may give the agent an opportunity to claim their account and validated with an email or phone number. The agent may have a customer profile automatically generated with data, for example, their profile picture, listings, reviews from buyers or renters, analytical stats, location, contact information, contact form, and the like.

Listing real estate properties in PadTime may be described herein. Agents may manually create a new listing and submit it for approval. Agents may connect their Application Programming Interface (API) or database endpoints in eXtensible Market Language (XML), JavaScript Object Notation (JSON), or other future data formats, to automatically submit all of their listings in bulk. The agents may later review, edit, delete, or promote for better search results and targeted advertisement. There may also be a smart engine that automatically adds listings to the system which agents may later claim. Information available on a property may include videos, stream recordings, images, description, locations, number of bedrooms and bathrooms, points of interest around the property, a map, and other relevant real estate property information. Listings may be confirmed by agents every three (3) weeks or else they will be deactivated. This may ensure that listings are never stale.

Agents that have active listings on PadTime may be expected to reply within two (2) weeks of an inquiry in order to keep the listing active. If a listing from an agent does not get response for more than two (2) weeks, the listing may get deactivated automatically and a notification may be sent to the agent. The notification may show a detailed summary of active and inactive properties that the agent can either confirm for removal or re-listing. Unanswered properties may automatically be deactivated.

A search engine may allow users to search for real estate properties using specific input parameters, for example, number of locations, property type, property details, points of interests, geolocation from the user's device, and the like. A renter or buyer may submit an application for a property of interest if the agent enables the online application feature for the listed property.

A system for requesting a remote live showing may be described herein. A user may be able to request a live showing from the agent by performing one of the following actions: a request via the built in scheduling system that may be displayed on the search results and property's page; a request via email from the user to the agent, an internal message from the user to the agent, or a calendar scheduling system displayed throughout the website.

A renter may propose a time and date for a showing. Once a renter requests a time and date for the showing, a showing may be scheduled on a condition that the agent accepts the request. The renter may then be registered for the showing. Agents may then schedule the showing based on the time and date. Additionally or alternatively, the scheduling may be set up by the agent; the renter may not need to suggest a proposed time and date.

A renter may directly register for an existing showing that an agent may have previously scheduled. Information about registered renters may be shared with the agents.

A registered renter, buyer, or other interested parties (further disclosed herein) may receive a notification about the live showing before it begins. The live showing may be initiated by the agent who acts as a “host.” The host may use a computer or mobile device to stream a video from their location. The agent may also use multiple devices at the same time to stream multiple videos. For example, the agent may stream from a laptop and a phone simultaneously. For example, the computer may be stationary, while the agent walks around with a phone.

A renter or buyer may join the showing and wait for the live stream to begin. A countdown may be shown illustrating the amount of time remaining until the stream begins. Additionally, there may be a space on the screen for the agent to post live updates or change the title of the showing.

The renter or buyer may communicate with the agent by leaving comments during the showing. The renter or buyer may see how many other attendees are watching the live showing. The renter or buyer may only see his or her comments. The renter or buyer may leave the session and join back as long as the session is still active.

A user may get live updates about the live showing, newly listed properties, and other relevant information on desktop and mobile apps.

Mini-Customer Relationship Management (CRM) for agents may be disclosed herein. The PadTime system may provide metrics on property views and statistics, for example, which property type and locations renters or buyers are more interested. The PadTime system may provide metrics on showings, for example, scheduled, completed, or cancelled showings. The PadTime system may provide information on registered or attended renters or buyers. The PadTime system may provide contact information on captured leads. The realtor may be able to manage their contacts or interested leads into group to be able to later send mass messages or to send Uniform Resource Locators (URLs) to upcoming showings. For example, a group may be ‘interested in 2 bed/2 bath apartment in Manhattan.’

Lead generation may be described herein. Listings may be liked by renters or buyers. On a condition that the listing is liked or ‘interested’, the information of the renter or buyer may be shared with the realtor, which may be known as a lead. The realtor may blast and share a live showing link or a previously recorded showing link to the users through an in-app notification, in-app message, email, text, social media, or the like.

Realtors may set up preprogrammed blasting notifications on their profiles and listings. For example, a realtor may schedule notifications to be sent out 5, 10, or 15 minutes, or any other desired timeframe, before a showing begins via channels to a target audience.

The renter or buyer search activities may be captured using a built-in software. Activities on the following key attributes may be captured: location, number of bedrooms, number of bathrooms, price range, and the like. Each attribute may be assigned a score based on a number of times they occur in each search result session. The combination with the highest score may be assigned to the user profile. Additionally, information for the logged in user may be captured and those values may be stored in session variables.

For example, a user profile may scoring/desired property assessment may include that the user is interested in a 2 bedroom, 2 bathroom apartment in Manhattan ranging from $4000-$5000 per month. In this example, a profile score accuracy may be 90% for ‘2 bedroom’ (which appeared in 9 out of 10 search results), 100% for ‘2 bathroom’ (which appeared in 10 out of 10 search results, and 80% ‘4000-5000 rent range’ (which appeared in 8 out of 10 search results). The above renter or buyer is then advertised to agents as a person who is interested in a 2-bedroom, 2-bathroom property in Manhattan in a price range of $4000-$500 who is now either online or was last active within a time range. Other key attributes that may be captured include credit score, salary range, and the like. Qualified or prescreened leads may confirm credit scores (a bad credit score: below 690, an average credit score: 690-710, a good credit score: above 710), salary (40:1 salary to rent ration), eviction history, background check, and the like.

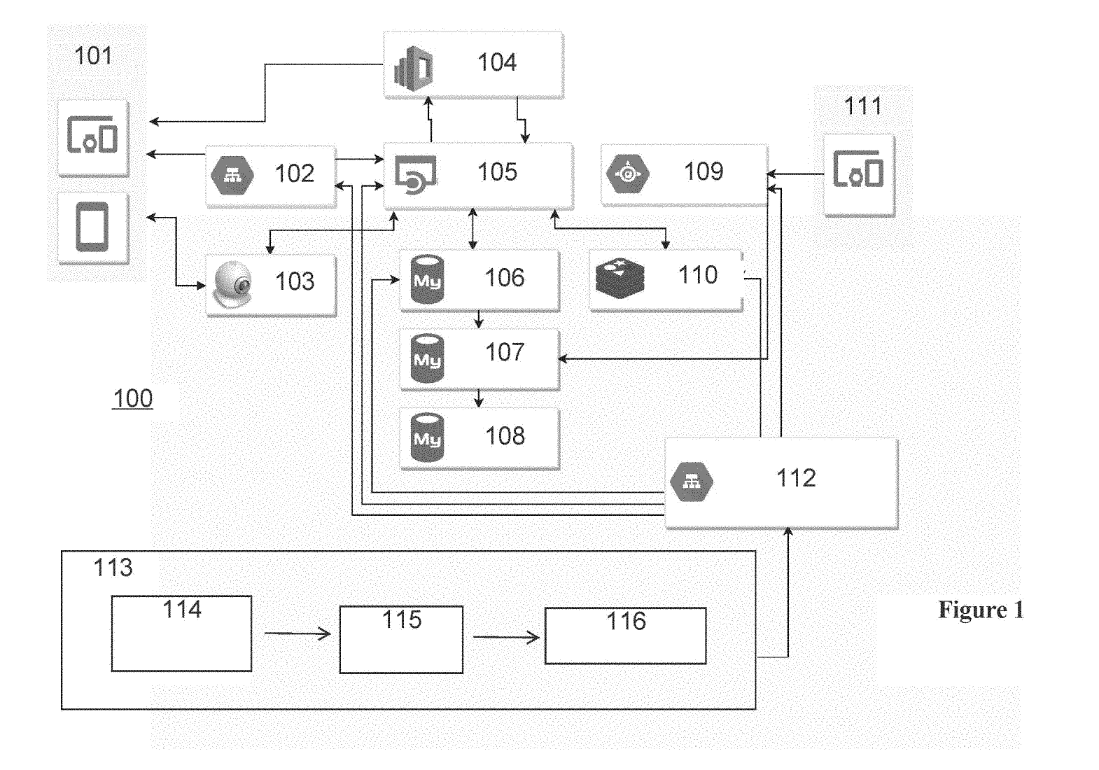

FIG. 1 is an example architecture for the PadTime Live Showing system. The architecture 100 may include several elements including multiple devices 101, a cloud load balancing element 102, a video streaming server 103, an image host 104, an Application Programming Interface (API) and web server 105, a database cluster master 106, a slave database A 107, a slave database B 108, and administrative web server 109, a redis database 110, an administrator devices 111, a cloud computing platform 112, and a code deployment element 113.

For example, the multiple devices 101 may include cell phones, computers, tablets, and the like. These multiple devices 101 may receive data from the image host 104, the cloud load balancing element 102. The multiple devices 101 may transmit and receive data from the video streaming server 103. The image host 104 may transmit and receive data from the API and web server 105. The cloud load balancing element 102 may transmit data to the API and web server 105. The video streaming server may transmit and receive data from the API and web server 105.

The API and web server 105 transmit and receive date from both the database cluster master 106 and the redis database 110. The database cluster master 106 may transmit data to the slave database A 107 and receive data from the cloud computing platform 112. The slave database A 107 may transmit data to slave database B 108.

The cloud computing platform 112 may transmit data to the cloud load balancing element 102, the API and web server 105, the database cluster master 106, the redis database 110, and the administrative web server 109. The cloud computing platform 112 may receive data from the code deployment element 113. The code deploy element 113 may include a code docker 114 that may transmit data to a github 115 that may transmit data to an automated deployment element 116.

The administrative web server 109 may transmit data to the slave database A 107 and received data from administrative devices 111.

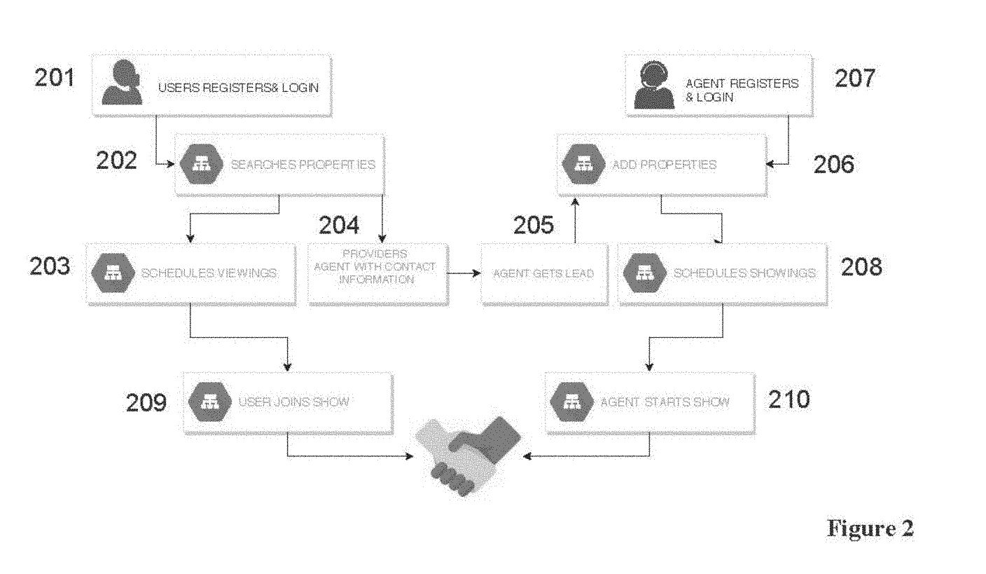

FIG. 2 is an example website flow of the PadTime Live Showing system. A user (either a buyer or a renter) may register and login to the PadTime Live Showing program 201. Once the user has registered and logged in, the user may then search properties on the server 202. On a condition that the user finds a property they are interested in, the user may schedule a viewing of the property 203 and provide the agent with contact information 204.

The agent may register and login to the PadTime Live Showing program 207. Once the agent has registered and logged in, the agent may add properties to the database 206. The agent may receive leads from the client 205 based on the added properties. Based on the received leads, the agent may schedule a showing of the property 208. At the arranged time and date, the agent may start the showing 210 and the renter or buyer may join the showing 209.

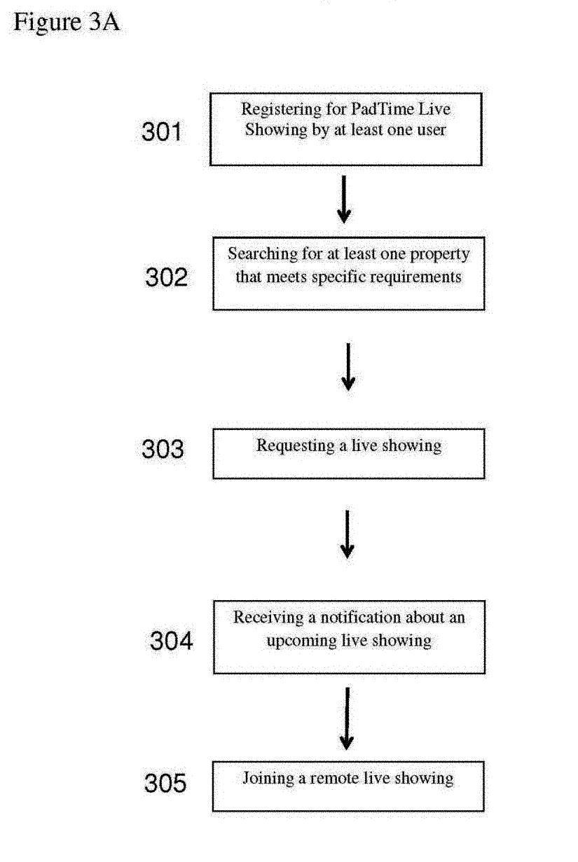

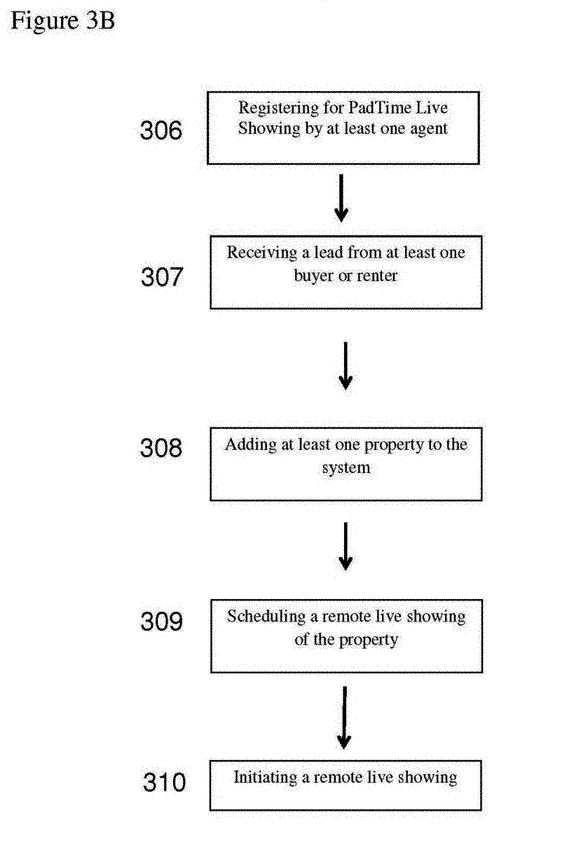

FIG. 3A is a first example method of the PadTime Live Showing system. At least one buyer/renter may register for the PadTime Live Showing system 301. The at least one buyer/renter may search for at least one property that meets specific requirements of the at least one buyer 302. The at least one buyer/renter may request a live showing of the at least one property 303. The at least one buyer/renter may receive a notification about an upcoming live showing for the at least one property 304. The at least one buyer/renter may then join a remote live showing 305.

FIG. 3B is a second example method of the PadTime Live Showing system. At least one agent may register of the PadTime Live Showing system 306. The at least one agent may receive a lead from at least one buyer 307. The at least one agent may add at least one property to the system based on the received lead 308. The at least one agent may schedule a showing of the at least one property 309. The at least one agent may then initiate a remote live showing 310.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

It should be understood that as disclosed and discussed herein, instances of invisible, hidden or transparent elements, may include cases or instances of the elements in a semi-visible or transparent states (i.e. not fully transparent states).

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

While multiple embodiments are disclosed, still other embodiments of the present invention will become apparent to those skilled in the art from this detailed description. There may be aspects of this invention that may be practiced without the implementation of some features as they are described. It should be understood that some details have not been described in detail in order to not unnecessarily obscure focus of the invention. The invention is capable of myriad modifications in various obvious aspects, all without departing from the spirit and scope of the present invention. Accordingly, the drawings and descriptions are to be regarded as illustrative in nature and not restrictive.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claims. It is intended that broader claims will be submitted in an application that claims the benefit of priority from this application.

What is claimed:

1. A method for PadTime remote live showings of real estate properties, the method comprising:
registering, by at least one user, for a remote live showing system;
searching, by the at least one user, for at least one property that meets specific requirements of the at least one user;
requesting, by the at least one user, a live showing of the at least one property; and
joining, by at the least one user, a remote live showing.

2. The method of claim 1, wherein registering for the remote live showing system includes contact information of the at least one user.

3. The method of claim 1, wherein the specific requirement is any one of a location, a number of bedrooms, a number of bathrooms, and a price range.

4. The method of claim 1, wherein the at least one user request a live showing by using any one of a built-in scheduling system, an email to the at least one agent, an internal message to the at least one agent, and a calendar scheduling system.

5. The method of claim 1, wherein the at least one user suggest a time and date for the remote live showing.

6. The method of claim 1, wherein the at least one user can communicate with the at least one agent during the remote live showing.

7. The method of claim 1, wherein the at least one user is notified of how many other attendees are viewing the remote live showing.

8. The method of claim 1, wherein the at least one user can rejoin the remote live showing after leaving on a condition that the remote live showing is still active.

9. The method of claim 1, further comprising:
receiving a notification about the remote live showing before it begins.

10. The method of claim 1, wherein the at least one user is a buyer.

11. The method of claim 1, wherein the at least one user is a renter.

12. A method for a remote live showing of real estate properties, the method comprising:
registering, by at least one agent, for a remote live showing system;
receiving, by at least one agent, a lead from at least one user;
scheduling, by at least one agent, a showing of the at least one property; and
initiating, by at least one agent, a remote live showing.

13. The method of claim 12, wherein a profile of the at least one agent is automatically generated with any one of their profile picture, listings, reviews, location, and contact information.

14. The method of claim 12, wherein the at least one agent shares a remote live showing link.

15. The method of claim 12, wherein the at least one agent sets up a preprogrammed blast notification.

16. The method of claim 12, wherein the at least one agent manages leads into groups for mass messaging.

17. The method of claim 12, wherein the at least one agent receives metrics on properties and showings.

18. The method of claim 17, wherein the metrics are based on any one of a number of property views, statistics on property types, and location the at least one user is interested in.

19. The method of claim 12, wherein the at least one agent advertises listing and showings to the at least one user directly based on the activity of the at least one user.

20. The method of claim 12, wherein the at least one user is a buyer.
